(19) United States
(12) Patent Application Publication
(10) Pub. No.: US 2003/0050895 A1
(43) Pub. Date: Mar. 13, 2003

(54) Automated volume license agreement method and apparatus

(76) Inventors: Rick Dedrick, Hillsboro, OR (US); Bakul C. Pandit, Beaverton, OR (US); Jeanne M. Koski, Beaverton, OR (US)

Correspondence Address: Donna Jo Coningsby, Blakely Sokoloff Taylor & Zafman LLP, 12400 Wilshire Boulevard, 7th Floor, Los Angeles, CA, 90025, US

(21) Appl. No.: 09/541,391

(22) Filed: Mar. 31, 2000

(51) Int. Cl. G06F 17/60

(52) U.S. Cl. 705/59

(57) ABSTRACT

An automated volume license agreement (“AVLA”) method and apparatus automates the management of volume license agreements (“VLA”). VLAs from different publishers and distributors are maintained on an AVLA Clearinghouse. The clearinghouse is accessible to the publishers, distributors, and customers over a secure network or the Internet. A corporate customer accesses the clearinghouse to obtain the latest rules embodied in a VLA in response to a purchaser's request to purchase a product sold under the VLA. An AVLA rules engine dynamically extracts the rules and applies them to the historical purchase data for the product that is compiled on the AVLA transaction database to obtain the latest volume discount pricing steps to which the purchaser is entitled. An AVLA pricing monitor, in turn, applies the latest volume discount step to generate current pricing information for display to the purchaser for her review prior to purchasing the requested product. This insures that the corporate purchaser is always presented with the lowest price available for each product that is purchased under a VLA. As a consequence, the role of the corporate reseller who physically monitors product purchases on behalf of corporations is reduced or eliminated. Distributors, publishers, and customers can communicate more rapidly and efficiently to negotiate and update their VLAs in response to changing market conditions.

### BACKGROUND OF THE INVENTION

1. Field of the Invention

The present invention relates generally to electronic commerce for electronic products. In particular, the present invention relates to technology that automates the management of volume license agreements for electronic products.

2. Background Information

Business corporations and other enterprises are one of the largest consumers of packaged software as well as numerous other types of electronic products, including electronic databases, books, digital video, electronic works of art, electronic graphics, electronic magazines and brochures, and digital audio creations and recordings. The Software Information Industry Association reports that businesses in the United States spent $24 billion dollars on business software products installed on personal computer platforms last year alone. (Packaged Software Industry Revenue and Growth, Software Information Industry Association, http://www.siia.net/pubs/research/softwareoverview.htm). Since businesses typically need to purchase hundreds or even thousands of copies of a particular product, they are often able to negotiate a volume license agreement (“VLA”).

A VLA offers volume discounts for electronic products based on measures such as the actual number of client computers (also referred to as seats) on which the product is installed. For example, Microsoft Corporation offers its customers multiple types of VLAs. For customers with 1,000 or more seats and mixed product requirements, they offer tiered pricing with discounts based upon forecasted volume. Such agreements can be difficult to administer, particularly since the price of a particular product can fluctuate periodically depending on whether the customer's actual purchases under the VLA meet the forecasted volume.

As a result of their tremendous investment in licensed electronic products, large corporate enterprises are increasingly negotiating VLAs as a way to control costs. In order to administer the VLAs, the corporate enterprise must continually monitor purchases in order to reap the full benefit of the volume discounts. Typically, VLAs are manually negotiated between a corporate customer 140 and a distributor 120 using the corporate reseller 130 as a liason. Once a VLA is negotiated, the publisher 110 issues a master license to the corporate customer 140 under which individual seat licenses are purchased. Each individual purchase generates its own transaction which must be reconciled under the master license to obtain the benefit of the VLA discount. For example, in a VLA covering mixed product offerings and using a tiered pricing discount based on forecasted volume (such as that offered by Microsoft), the publisher 110 assigns point values to each purchased product and places the corporate customer 140 at a certain discount step depending on the number of accumulated points. For example, an accumulation of 50,000 points might entitle the corporate customer 140 to placement in the 10% discount step, and of 100,000 points, to a placement in the 15% discount step, and so forth.

Today, the corporate customer 140 employs corporate resellers 130 to continually monitor their purchases and negotiate the movement from one discount step to another to insure that the corporate customer 140 is getting the best price under their VLA. Some VLA discounts may even be retroactive depending on the publisher's 110 or corporate reseller's 130 rules for administering the VLA. Therefore, accurate monitoring is extremely important as it can result in a significant savings for large enterprises. As a consequence, the cost of monitoring is labor intensive and reduces the potential savings to corporate customers 140 under the VLA.

Since prior art methods of administering VLAs are manual, they also do not take advantage of recent advances in the technology for licensing software and other electronic products, including the use of electronic commerce to electronically manage and distribute licenses for software and other and electronic products installed on remote computers. By not tracking the electronic purchase or distribution of a particular product, business administrators lose valuable opportunities for obtaining timely pricing discounts and controlling electronic asset costs by tracking and reconciling the electronic purchases of products sold under their VLAs.

Accordingly, a new approach for providing automated management of VLAs that facilitates timely discount pricing is desirable. An automated VLA can monitor purchases under the VLA in real-time and insure that corporate customers 140 are always presented with the lowest possible cost products that are available under the terms of the VLA. An automated VLA can also enable publishers 110 to provide more up-to-date information about product offerings under the VLA, and enable distributors 120 and their corporate customers 140 to competitively negotiate and modify VLAs more rapidly in response to changing market conditions. The role of the corporate reseller 130 may be sharply reduced, if not completely eliminated, by facilitating the direct communication between the publisher 110 and corporate customer 140. The integration of the management of VLAs with electronic commerce in a user-friendly way presents a unique set of challenges, requiring a new and novel solution.

### SUMMARY

According to one aspect of the invention, a method is provided in which a purchase history for a product is recorded pursuant to a stored volume license agreement. The method further provides for generating a purchase price in accordance with both the volume license agreement and the purchase history. In response to a purchaser request, the method further provides for transacting the purchase of the product for the generated purchase price.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the prior art scenarios for negotiating and administering a VLA;

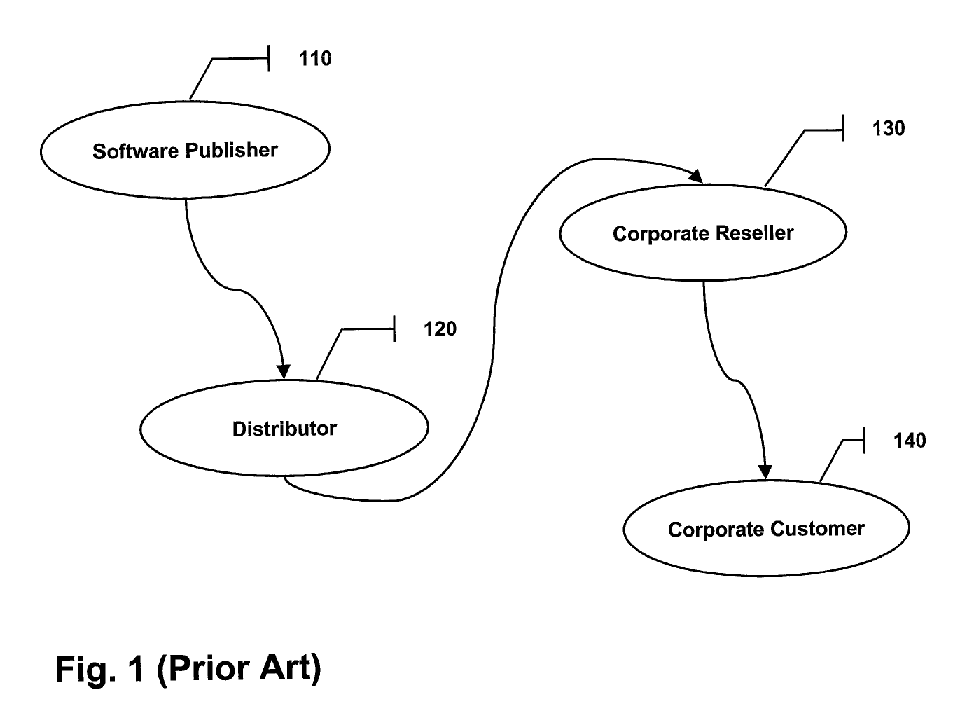

FIG. 2 illustrates an overview of the present invention and operating environment configured in accordance with one embodiment

FIG. 3 illustrates a block diagram of the functional components of the present invention in accordance with one embodiment;

FIG. 4 illustrates a general-purpose computer system upon which an embodiment of the present invention may be implemented;

FIG. 5 illustrates a block diagram of a typical scenario in which the present invention may be used in accordance with one embodiment;

FIG. 6 illustrates an example of a Order page in accordance with one embodiment.

### DETAILED DESCRIPTION OF THE INVENTION

In the following description various aspects of the present invention, an automated volume license agreement (hereinafter “AVLA”) method and apparatus, will be described. Specific details will be set forth in order to provide a thorough understanding of the present invention. However, it will be apparent to those skilled in the art that the present invention may be practiced with only some or all of the described aspects of the present invention, and with or without some or all of the specific details. In some instances, well known features may be omitted or simplified in order not to obscure the present invention.

Various operations will be described as multiple discrete steps performed in turn in a manner that is most helpful in understanding the present invention. However, the order of description should not be construed as to imply that these operations are necessarily performed in the order they are presented, or even order dependent. Lastly, repeated usage of the phrase “in one embodiment” does not necessarily refer to the same embodiment, although it may.

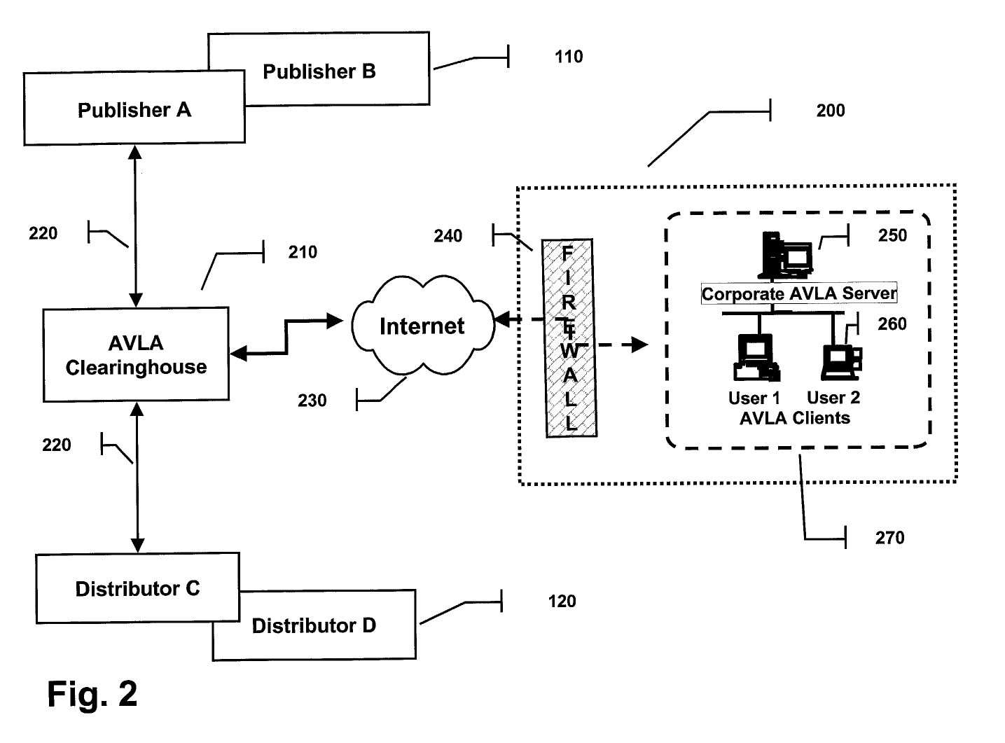

Referring now to FIG. 2, wherein an overview of the AVLA method and apparatus 200 in an operating environment configured in accordance with one embodiment is shown. As illustrated, publishers A and B 110 as well as distributors C and D 120, in communication with an AVLA Clearinghouse 210, either via a secure network connection 220 or over the Internet 230, or a combination thereof, creates or updates an electronic VLA for storage in the AVLA Clearinghouse 210. The electronic VLA reflects the negotiated VLA between the customer 140 and the publisher 110. The publishers A and B further update the information about the products offered under the VLA to the AVLA Clearinghouse 210. The corporate AVLA server 250, in communication with the AVLA Clearinghouse 210 over the Internet 230 pulls a copy of their VLA through firewall 240 for storing on AVLA server 250 and for processing in response to purchase requests by corporate AVLA clients User 1 and User2 260. Using the product's purchase history the corporate AVLA server prices the requested product and facilitates the transaction of the purchase by the corporate AVLA clients 260. Depending on the location of the AVLA users 1 and 2 260 the pricing and transaction of the purchase of the electronic product may occur between an AVLA server 250 and AVLA client 260 residing within a local area network 270, or may occur between an AVLA server 250 and AVLA client 260 residing within an external network served by a remote server (not shown), or some variation of the foregoing configuration.

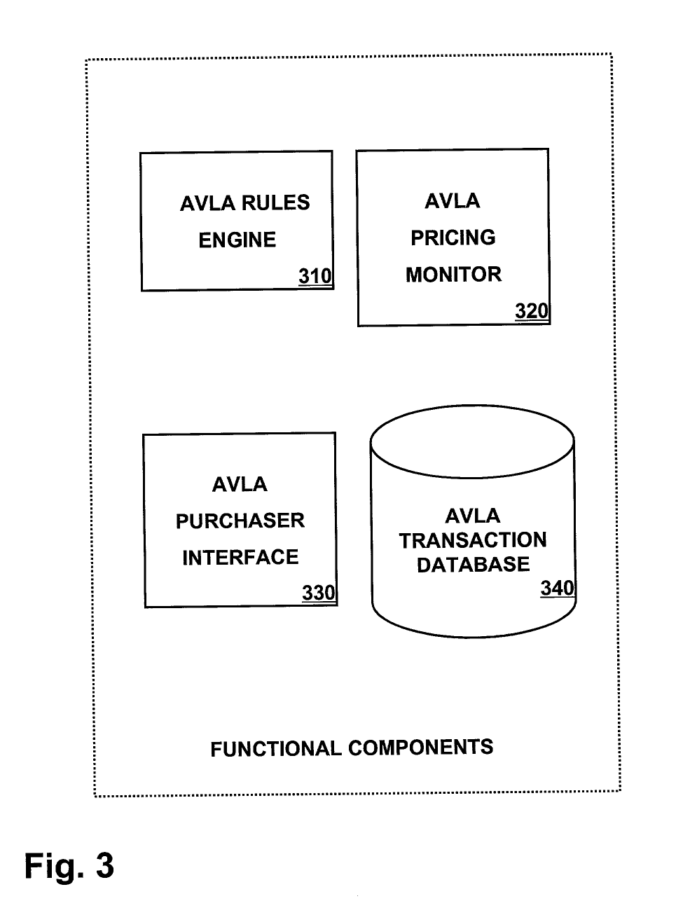

Referring now to FIG. 3, wherein a block diagram illustrating the functional components of the AVLA method and apparatus are shown. The functional components include an AVLA rules engine 310, an AVLA pricing monitor 320, an AVLA purchaser interface 330, and an AVLA transaction database 340. Some of the functions performed by the AVLA rules engine 310 include accessing the VLAs pulled from the AVLA Clearinghouse 210, extracting and maintaining the rules for automating the VLA, including, for example, the points credited for each product offered under the VLA, the number of points required for each discount step, and the percentage discount associated with each discount step. Some of the functions performed by the AVLA pricing monitor 220 include accessing the historical purchasing data for a requested product, determining whether the discount step is current, and modifying the discount step, if necessary, in conjunction with the AVLA rules engine 310 and the historical purchasing data. In one embodiment, another function of the AVLA rules engine is to further determine whether discount pricing is available based on a profile of the AVLA client/user 260 requesting the product, to insure that only the appropriate AVLA client/users 260 are able to view and purchase products at that discounted price. Some of the functions performed by the AVLA purchaser interface 330 include, obtaining the current discount step from the AVLA pricing monitor 320 and dynamically calculating and displaying the current price of a product in response to a purchase request by a AVLA client/user 260. The AVLA purchaser interface 330 is also responsible for maintaining the historical purchase data on the AVLA transaction database 340 for each product purchased under a VLA, and for facilitating the transaction of the purchase in response to a request by a AVLA client/user 260.

The AVLA rules engine 310 and AVLA pricing monitor 320 perform together in conjunction with historical purchase data stored on the AVLA transaction database 340 to provide the current product pricing information to the AVLA purchaser interface 330. In one embodiment, the AVLA purchaser interface 330 in operation with an electronic product catalog (not shown) provides the AVLA client/user 260 with an entry point into the AVLA through which the AVLA client/users 260 interact with the AVLA rules engine 310, AVLA pricing monitor 320, and AVLA transaction database 340. In one embodiment, the AVLA purchaser interface 330 may use the browser facilities of the platform upon which the AVLA is implemented. An alternative embodiment may be implemented as a separate application program that uses the graphical user interface facilities of the platform's operating system. The AVLA transaction database 340 is the repository for storing persistent data for the purchases of products under a VLA and processed by these other functional components. The AVLA transaction database 340 may be comprised of one physical database or a combination of different physical databases depending on the configuration of the various server and client computers on which the AVLA method and apparatus is implemented.

Referring now to FIGS. 2 and 3 together, it should be understood that some or all of the above-described component functions 310, 320, 330, or 340 may be performed by one or more of the various corporate AVLA servers 250, and that some of the component functions may be performed by the AVLA clients 260. Furthermore, the functional components may reside on the AVLA clients 260 and/or AVLA servers 250, and/or the AVLA Clearinghouse 210, all of which communicate over a local area network 270 as shown, or over the Internet 230, or over a wide area network or combination of networks, or any other network configuration capable of connecting them. The physical database(s) comprising the AVLA transaction database component 340 may reside on one or more of the various AVLA servers 250, and portions of the database(s) may be replicated on one or more of the various AVLA clients 260 and periodically synchronized as needed with the data residing on the servers.

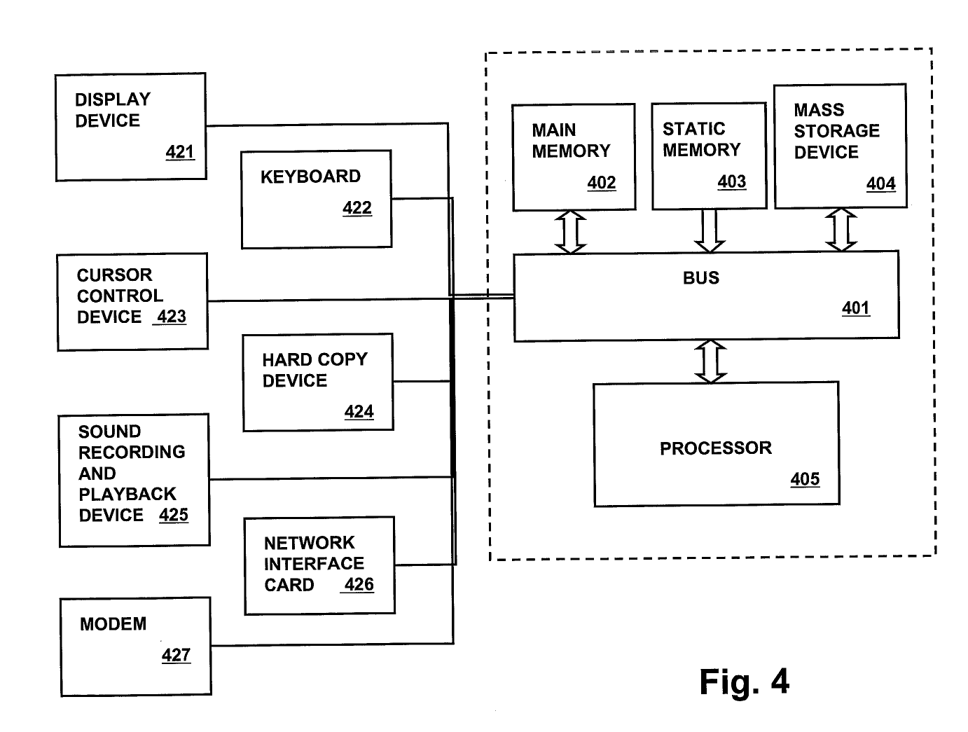

Referring now to FIG. 4, wherein a block diagram of a general-purpose computer system upon which an embodiment of the present invention may be implemented is shown. As illustrated, general-purpose computer system 400 comprises a bus 401, or other communications hardware and software, for communicating information, and a processor 402 coupled with bus 401 for processing information. Computer system 400 further comprises a random access memory (RAM) or other dynamic storage device 402 (referred to as main memory), coupled to bus 401 for storing information and instructions to be executed by processor 402. Computer system 400 also comprises a read only memory (ROM) 403, and/or other static storage device, coupled to bus 401 for storing static information and instructions for processor 402. Mass storage device 404 is coupled to bus 401 for storing information and instructions. In one embodiment, mass storage device 404 includes a library of historical purchasing data and VLA rules used to automate the VLA under which the products are purchased by the various AVLA client/users 260.

Furthermore, mass storage device 404, such as a magnetic disk or optical disk, and its corresponding disk drive, can be coupled to computer system 400. Computer system 400 can also be coupled via bus 401 to a display device 421 for displaying information to a computer user such as a network manager. Display device 421 is used to display windows containing a graphical user interface to information about the available products for which pricing and purchasing is facilitated by the AVLA method and apparatus. Display device 421 can include a frame buffer, specialized graphics rendering devices, a cathode ray tube (CRT), and/or flat pane display. An alphanumeric input device 422, including alphanumeric and other keys, is typically coupled to bus 401 for communicating information and command selections to processor 405. Another type of user input device is cursor control device 423, such as a mouse, a trackball, a pen, a touch screen, or cursor direction keys for communicating direction information and command selections to processor 405, and for controlling cursor movement on display device 421. This input device typically has two degrees of freedom in two axes, a first axis (e.g., the x-axis) and a second axis (e.g., the y-axis), which allows the device to specify positions in a plane. However, this invention should not be limited to input devices with only two degrees of freedom.

Another device that may be coupled to bus 401 is a hard copy device 424 which may be used for printing instructions, data, or other information on a medium such as paper, film, or similar types of media. Additionally, computer system 400 can be coupled to a device for sound recording, and/or playback 425, such as an audio digitizer coupled to a microphone for recording information. Further, the device may include a speaker that is coupled to a digital to analog (D/A) converter for playing back the digitized sounds.

Network interface card 426 is coupled to bus 401. Network interface card 426 is further coupled to an external computer network (not shown). Network interface card 426, in conjunction with appropriate data communications protocols (e.g., the TCP/IP suite of internetworking protocols), provide the means by which a AVLA method and apparatus operating on a general-purpose computer system 400 exchanges information with other devices coupled to the same computer network. Modem 427 is coupled to bus 401, and provides an alternate means of exchanging information with other devices for which a modem connection to an external computer network or device (not shown) can be established.

Computer system 400 and AVLA application software stored and executed therein as part of the AVLA method and apparatus operate in conjunction with an operating system with graphics capability, such as Microsoft's Windows operating system. Commercially available computer systems implementing the features of general-purpose computer system 400 include a broad range of operating system-based computers, including server computers, desktop computers, workstations, devices, or appliances. Furthermore, the present invention may be used in conjunction with various browser (e.g. Microsoft Internet Explorer or Netscape Navigator) and electronic mail applications (e.g. Microsoft Outlook, and Lotus Notes) or other messaging applications to yield an operational AVLA platform upon which an embodiment of the present invention may be implemented.

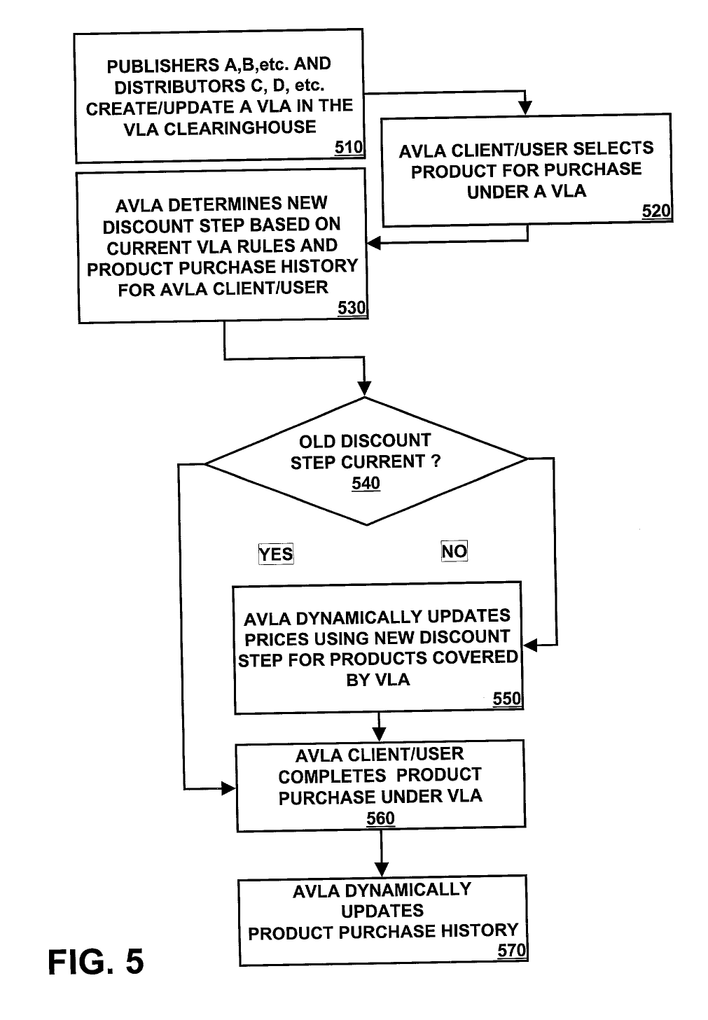

Referring now to FIG. 5, wherein a block diagram of a typical scenario in which the AVLA method and apparatus may be used in accordance with one embodiment, is shown. As illustrated, the process begins with publisher(s) A and B 110, and/or distributor(s) C and D 120, creating or updating a VLA 510 in the VLA Clearinghouse 210. The VLA may cover a variety of electronic products, including a software application, electronic book, electronic work of art, electronic graphics item, electronic magazine or brochure, or digital video or audio creation or recording.

The AVLA client/user then selects one of the products for purchase 520 under the VLA pulled from the VLA Clearinghouse 210 by using the AVLA purchaser interface 330. The AVLA obtains the current applicable version of the VLA from the AVLA Clearinghouse 210 and the purchase history for the product selected by the AVLA client/user 260. The AVLA then invokes the functions of the AVLA rules engine 310 and the AVLA pricing monitor 320 to determine the new discount step 530 to which the corporate customer 140 is entitled. The AVLA then determines whether the old discount step currently in use by the AVLA purchaser interface 330 is current 540 (i.e. the same as the newly determined discount step). If not, then the AVLA dynamically updates the requested product prices displayed by the AVLA purchaser interface to reflect the new discount step 210 to which the corporate customer 140 is now entitled. The AVLA client/user 260 completes the product purchase 560 using the best price available to the corporate customer 140 under the latest VLA from the AVLA clearinghouse 210. Finally, the AVLA dynamically updates the product's purchase history data on the AVLA transaction database 340 to reflect the completed purchase.

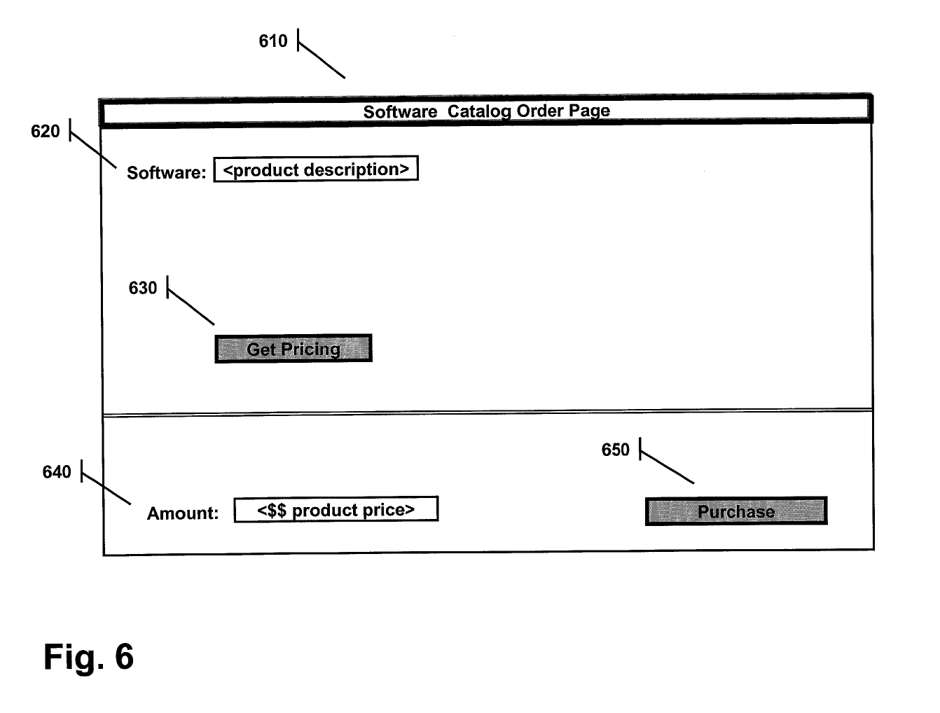

Referring now to FIG. 6, wherein one embodiment of an AVLA purchaser interface 610 for obtaining pricing information and completing a purchase of products sold under a VLA is shown. Using a menu-based or other navigational aid, the AVLA client/user 260 desiring to purchase a license for a product sold under a VLA using the AVLA navigates the AVLA purchaser interface 330 to cause the display of an Order page 610, as illustrated in FIG. 6. The AVLA client/user 260 can be any user authorized to purchase products for themselves or on behalf of another.

The Order page 610 contains, among other items, at least one input area 620 to enter or select information that will identify the product for which a license is desired. A command button or other graphical visual icon 630 (“Get Price”) is provided for affirmatively entering a command to obtain the latest pricing information for the selected product using the facilities of the AVLA. In a separate portion of the Order page 610 is provided an output area 640 to display the results of entering the command to obtain the latest pricing information. The AVLA client/user 260 is further provided with command button or other graphical visual icon 650 (“Purchase”) to carry out the purchase after reviewing the price displayed in output area 640. The sequence of AVLA client/user interactions with the Order page 610 is summarized in Table 1. It should be understood that the Order page 610 as shown is for descriptive purposes only, and that other variations for accomplishing the described entry, selections or commands to the AVLA purchaser interface 330 may be employed without departing from the principles of or exceeding the scope of the present invention.

TABLE 1

| Order | |
|---|---|
| 1. | Navigate to the Order page; |
| 2. | Select/enter the identification of the product to be purchased; |
| 3. | Click the Get Pricing button to obtain the latest pricing |
| | information under the VLA for the selected product; |
| 4. | Review the current price; and, if acceptable |
| 5. | Click the Purchase button to complete the purchase. |

Accordingly, a novel method and apparatus is described for an automated volume licensing agreement method and apparatus to automate the pricing and purchasing of products sold under volume license agreements.

EPILOGUE

From the foregoing description, those skilled in the art will recognize that many other variations of the present invention are possible. In particular, while the present invention has been described as being implemented in the AVLA servers 250, and AVLA client/users 260, some of the logic described in functional components 310, 320, 330, and 340, may be distributed in other components of a general-purpose computer system 400. Thus, the present invention is not limited by the details described. Instead, the present invention can be practiced with modifications and alterations within the spirit and scope of the appended claims.

What is claimed is:

1. An apparatus for use in a computer system comprising:
a repository for storing a volume license agreement for a product;
a repository for maintaining a purchase history for the product;
a pricing generator to generate a purchase price for the product in accordance with the volume license agreement and the purchase history; and
a purchase generator to display the purchase price and transact a purchase of the product in response to a user request.

2. The apparatus of claim 1, wherein the volume licensing agreement is obtained from a clearinghouse, the clearinghouse being remotely connected to the pricing generator over a communications network.

3. The apparatus of claim 2 wherein the communications network is the Internet.

4. The apparatus of claim 2 wherein the clearinghouse is further remotely connected to at least one of a plurality of publishers, the publishers periodically transmitting a new volume licensing agreement to the clearinghouse.

5. The apparatus of claim 2 wherein the clearinghouse is further remotely connected to at least one of a plurality of distributors, the distributors periodically transmitting a new volume licensing agreement to the clearinghouse.

6. The apparatus of claim 1, wherein the purchase history is updated to reflect the transacted purchase.

7. The apparatus of claim 1, further comprising:
a rules engine containing a set of rules for determining a discount step for the product in accordance with the volume licensing agreement, and the pricing generator calculates the current price in accordance with the discount step.

8. The apparatus of claim 7 wherein the rules engine further contains a set of rules for determining a discount step for the product in accordance with a profile of the user that requested the purchase.

9. The apparatus of claim 1, further comprising:
an electronic distribution mechanism to automatically install the purchased product in response to a user request.

10. A computer-readable medium having computer-executable instructions for performing:
storing a volume license agreement for a product;
maintaining a purchase history for the product;
generating a purchase price for the product in accordance with the volume license agreement and the purchase history; and
transacting a purchase of the product in response to a user approving the purchase price.

11. The computer-readable medium of claim 10 having computer-executable instructions for further performing:
communicating the purchase price to the user in a visual display, and communicating the approval by the user to purchase in a response to the visual display.

12. The computer-readable medium of claim 10 having computer-executable instructions for further performing:
communicating the purchase price to the user in an electronic message, and communicating the approval by the user to purchase in a reply to the electronic message.

13. The computer-readable medium of claim 10 wherein the volume license agreement storing computer-executable instructions further include instructions to extract the volume license agreement from a remote clearinghouse.

14. The computer-readable medium of claim 10 wherein the volume license agreement storing instructions further include extracting updated information about the products license under the volume licensing agreement

15. The computer-readable medium of claim 10 wherein the purchase price generating instructions further contain instructions for determining a discount step for the product in accordance with the volume licensing agreement and the purchase history, and for generating the purchase price in accordance with the discount step.

16. The computer-readable medium of claim 15 wherein the purchase price generating instructions further contain instructions for determining a discount step for the product in accordance with a user profile of the user approving the purchase price.

17. A computer implemented method comprising:
storing a volume license agreement for a product in a repository;
recording a history of purchases of the product pursuant to the volume license agreement;
generating a price for a purchase of the product in accordance with the volume license agreement and the history of purchases;
transacting the purchase of the product for the generated price in response to a purchaser request.

18. The method of claim 17 further comprising:
displaying the generated price to the purchaser for approval before transacting the purchase.

19. The method of claim 17 wherein recording a history of purchases includes recording a point value associated with the purchase in accordance with the volume license agreement.

20. The method of claim 17 wherein recording a history of purchases includes recording the date associated with the purchase.

21. The method of claim 17 wherein recording a history of purchases includes recording a profile of the purchaser that requested the purchase.

22. The method of claim 17 wherein the purchase price is generated in response to a purchaser request.

23. The method of claim 17 wherein the purchase price is generated by determining a discount step for the product in accordance with the volume licensing agreement and the recorded history of purchases.

24. The method of claim 2 wherein the clearinghouse is maintained on a web server computer accessible over the Internet
